(19) United States
(12) Patent Application Publication
(10) Pub. No.: US 2017/0085871 A1
(43) Pub. Date: Mar. 23, 2017

(54) REAL TIME VIDEO CODING SYSTEM WITH ERROR RECOVERY USING EARLIER REFERENCE PICTURE

(71) Applicant: ATI Technologies ULC, Markham (CA)

(72) Inventors: Jiao Wang, Markham (CA); Ying Zhang, Markham (CA)

(21) Appl. No.: 14/861,049

(22) Filed: Sep. 22, 2015

(51) Int. Cl. H04N 19/105; H04N 19/166; H04N 19/895

(52) U.S. Cl. CPC H04N 19/105; H04N 19/895; H04N 19/166

(57) ABSTRACT

In a video coding system, a method includes transmitting a first encoded picture from an encoder for reception by a decoder as part of an encoded bitstream. The first encoded picture acts a first reference picture for one or more subsequent pictures in the output encoded bitstream. The method further includes receiving, at the encoder, an indication from the decoder that there was an error in receiving the first encoded picture, and selecting a second reference picture from a buffer of reference pictures at the encoder. The selected second reference picture selected as being earlier than the first reference picture in an encoding order of the encoded bitstream. The method further includes configuring the encoder to encode a set of one or more pictures for the encoded bitstream using the second reference picture and signaling the first reference picture as a non-reference picture.

### BACKGROUND

Field of the Disclosure

The present disclosure relates generally to multimedia systems and, more particularly, to video coding systems.

Description of the Related Art

Many video compression schemes employ a predictive encoding process, in which the spatial redundancy between successive pictures is leveraged by converting pixel-based representations of the pictures to motion-based representations. The predictive encoding process typically entails partitioning a picture into a set of blocks, and for each block finding a corresponding most-similar block of a previous reference picture and representing the block in the current picture as a motion vector that defines the displacement of the block from its position in the current picture to its position in the reference picture and a residue that represents the differences between the block and the most-similar block.

More recent video compression schemes, such as the H.264 and H.265 specifications, enable the use of multiple reference pictures in this predictive encoding process, and thus video coding systems employing such video compression schemes often utilize a decoded picture buffer at each of the encoder and decoder to buffer reference pictures recently used in the encoding process. Generally, the decoded picture buffer maintained by the decoder is at least partially synchronized with the decoded picture buffer maintained at the encoder (that is, the decoder-side decoded picture buffer mirrors the encoder-side decoded picture buffer). Through this synchronization, the decoder can decode a predicted picture using local copies of the one or more reference pictures employed by the encoder to encode the predicted picture.

The encoder and decoder typically are linked via a communication channel that is subject to data loss or data corruption, which may cause the decoder to receive a reference picture that has been corrupted in transit or otherwise has been subjected to a transmission error. In real-time video coding systems, it often is impracticable to arrange for retransmission of the corrupted reference picture, and the decoder may be forced to continue with decoding of subsequent pictures that were predicted from the corrupted reference picture. The result often is that the error in the corrupted reference picture propagates to all subsequent pictures predicted therefrom, which introduces perceptible visual artifacts in the corresponding displayed content.

Conventional approaches to mitigating the effects of transmission errors or other causes of reference picture corruption often rely on insertion of intra-coded picture information. To illustrate, one conventional approach relies on the periodic insertion of an Instantaneous Decoder Refresh (IDR) picture to start a new group of pictures (GOP). While this approach limits the impact of a corrupted reference picture to only the GOP in which the corrupted reference picture was included, the GOP may include a significant number of predicted pictures impacted by the corrupted reference picture. Another conventional approach to corrupted reference picture mitigation is to force an IDR picture whenever the decoder detects a corrupted reference picture or other transmission error. Under this approach, the encoder is configured to generate and transmit an IDR picture when the decoder signals an error, which can provide a more rapid corrective action than the periodic insertion of IDR pictures. However, both approaches rely on the uninformed use of otherwise-unnecessary intra-coded picture information to correct for a transmission error. As intra-coded picture information typically requires a significantly higher bit rate to transmit than inter-coded picture information, this reliance on intra-coded picture information for error recovery can result in an increased overall bit rate and correspondingly lower compression efficiency for the transmitted bitstream.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram illustrating a real-time video coding system in accordance with some embodiments.

FIG. 2 is a block diagram illustrating an encoder of the video coding system of FIG. 1 in accordance with some embodiments.

FIG. 3 is a block diagram illustrating a decoder of the video coding system of FIG. 1 in accordance with some embodiments.

FIG. 4 is a flow diagram illustrating a method of encoding pictures and of error recovery using an earlier reference picture at the encoder of FIG. 2 in accordance with at least one embodiment of the present disclosure.

FIG. 5 is a flow diagram illustrating a method of the decoder of FIG. 3 in decoding encoded pictures and signaling a corrupted reference picture in accordance with at least one embodiment of the present disclosure.

FIG. 6 is a diagram illustrating an example error recovery operation using an earlier reference picture in a video coding system in accordance with at least one embodiment of the present disclosure.

### DETAILED DESCRIPTION

Conventional approaches to recovery from transmission errors impacting reference pictures at the decode side of a video coding system typically rely on some form of intra-coding recovery, such as the use of periodic IDR picture insertion. These intra-coding-based recovery approaches significantly increase the bit rate during the error recovery process. In contrast, the present disclosure describes error recovery techniques that may avoid the need for intra-coding to recover from a corrupted reference picture and therefore exhibit a relatively low bitrate during the recovery process. In at least one embodiment, each of the encoder and decoder in a real-time video coding system utilizes a corresponding decoded picture buffer (DPB) to store one or more reference pictures for the encoding and decoding of inter-coded pictures in the encoded bitstream transmitted from the encoder to the decoder. The decoder-side DPB is synchronized to the encoder-side DPB such that the decoder-side DPB maintains copies of at least a subset of the reference pictures stored in the encoder-side DPB. A feedback channel is maintained via the communication channel linking the encoder and the decoder. When the decoder detects that a received reference picture has been corrupted (that is, impacted by a transmission error or other error), the decoder provides an indication of the corrupted status of the reference picture to the encoder via the feedback channel.

In response to this indication, an error recovery module at the encoder determines whether the encoder-side DPB stores a suitable reference picture (e.g., a long-term reference picture) that is earlier than the corrupted reference picture in the encoding order. If so, the error recovery module selects this earlier long-term reference picture (or selects one of the earlier reference pictures if there are multiple candidate reference pictures) and configures the encoder to use the selected earlier reference picture for encoding at least the current picture undergoing the encoding process and signals the reference picture that has been corrupted at the decoder as a non-reference picture, thereby changing the status of the corrupted picture from reference picture status to non-reference picture status in the DPBs. Due to the synchronization between the encoder-side DPB and the decoder-side DPB, the decoder has a copy of this selected earlier reference picture, and thus can decode the one or more inter-coded pictures generated by the encoder using the selected earlier reference picture. In this manner, the impact of the corrupted reference picture is limited to only those inter-coded pictures generated by the encoder from the reference picture that was corrupted up until the receipt of the indication of the corrupted picture. Moreover, by switching to use of an earlier reference picture and continuing to use inter-coding, the video coding system may recover from the corrupted reference picture using a lower bit rate than the bit rate normally needed for intra-coding-based error recovery processes.

In a typical implementation, the reference pictures in a DPB are classified as either “long-term” reference pictures or “short-term” reference pictures. As described in greater detail below, it often is more effective to select the earlier reference picture from the long-term reference pictures in the DPB, and thus selection of an earlier reference picture may be limited to selection from the long-term reference pictures, and example embodiments are described below in this context for ease of illustration. As such, reference to availability of, or selection of, a “suitable reference picture” may refer to the availability of, or selection of, a long-term reference picture.

In some embodiments, the encoder may employ a hybrid approach in that so long as a suitable earlier reference picture is available in the DPB, the encoder may utilize the inter-coding-based recovery process described above. However, in the event that a suitable earlier reference picture is not available in the DPB, the encoder may default to using an intra-coding-based error recovery approach, such as the generation and insertion of an IDR picture to start a new GOP, or through the use of an intra-refresh coded picture.

For ease of illustration, the techniques are described below in an example context of an H.264-compliant video coding system, and thus reference is made to certain aspects of the H.264 standard, such as “macroblock” and “picture.” However, these techniques may be beneficially implemented in conjunction with a variety of video coding standards that employ some form of reference buffer at both the encoder and the decoder, such as the H.265 standard, and thus reference to H.264 specific terms equally applies to the counterpart terms of these other standards unless otherwise noted. For example, “macroblock” may equally apply to “coded tree unit”, “picture” or “frame” may equally apply to “access unit”, and the like.

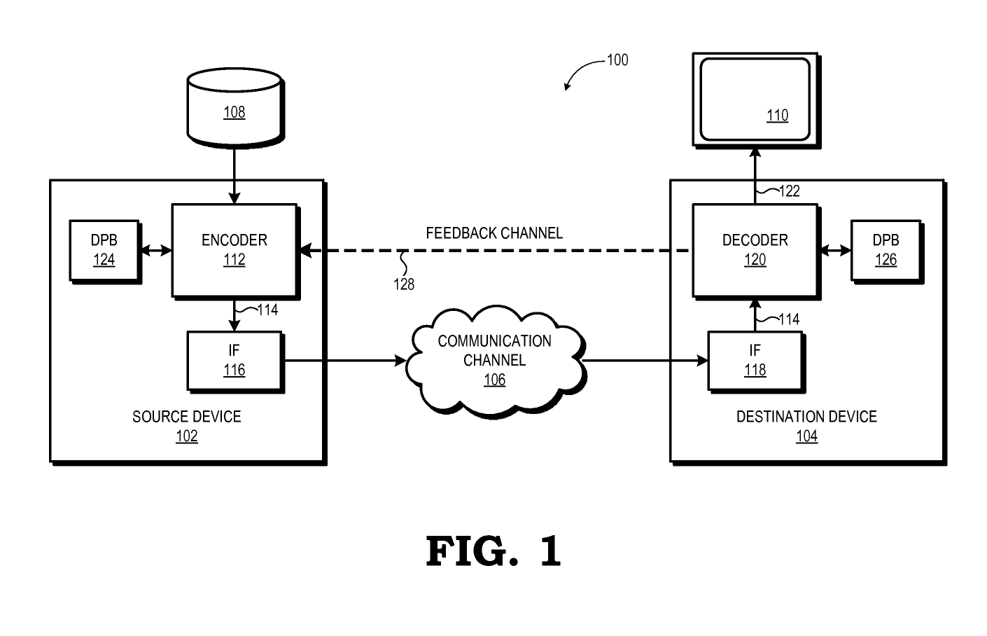

FIG. 1 illustrates a real-time video coding system 100 employing inter-coding-based error recovery in accordance with at least one embodiment of the present disclosure. In the depicted example, the video coding system 100 includes a source device 102 and a destination device 104 coupled via a communication channel 106. The source device 102 includes, or has access to, a multimedia content source 108 and the destination device 104 includes, or is coupled to, a display 110. The communication channel 106 may comprise a channel or link established through one or more networks, such as a connection over the Internet, a connection over a wired network (e.g., an Ethernet network), a connection over a wireless network (e.g., an IEEE 802.11 network or a cellular data network), or a combination thereof. The video coding system 100 may represent any of a variety of real-time multimedia systems, such as a multimedia server (one embodiment of the source device 102) streaming multimedia content to a cellular phone, tablet computer, notebook computer, desktop computer, gaming console, or other consumer multimedia device (embodiments of the destination device 104) via one or more networks. As another example, the video coding system 100 may comprise a video conferencing system in which each participant in the videoconferencing system employs both a source device 102 (for transmitting video and audio of the participant) and a destination device 104 (for receiving and displaying the video and audio from other participants).

As a general overview, the source device 102 includes an encoder 112 to encode multimedia content from the multimedia content source 108 to generate an encoded bitstream 114, and an interface 116 to a network that forms at least a part of the communication channel 106 to transmit, or stream, the encoded bitstream 114 as it is output by the encoder 112 to the destination device 104 via the communication channel 106. The multimedia content source 108 may comprise a data store or multimedia server, and the multimedia content may be supplied in an already encoded form, in which case the source device 102 operates to transcode the multimedia content to generate the encoded bitstream. In such instances, the source device 102 further may include a decoder (not shown) upstream of the encoder 112 so as to at least partially decode the encoded bitstream received from the multimedia content source 108. The destination device 104 includes an interface 118 connected to a network serving as at least a portion of the communication channel 106 to receive the encoded bitstream 114, a decoder 120 connected to the interface 118 to decode the received encoded bitstream 114 to generate a decoded bitstream 122, and a display interface (not shown) to control the display 110 based on the decoded bitstream 122 so as to display a sequence of pictures represented by the decoded bitstream 122.

To support the encoding and decoding process, the encoder 112 utilizes a decoded picture buffer (DPB) 124 to maintain recent reference pictures utilized by the encoder 112 to encode other pictures within the same group of pictures (GOP). Similarly, the decoder 120 utilizes a DPB 126 to maintain copies of at least a subset of these recent reference pictures for purposes of decoding the pictures encoded by the encoder 112 based on these same reference pictures. That is, the DPB 126 is at least partially synchronized to the DPB 124 so that the decoder 120 has access to copies of some or all of the same reference pictures found in the DPB 124. As described in greater detail below, the DPBs 124, 126 may be used for storage of short term reference pictures and long-term reference pictures, as well as for temporary buffering of decoded pictures before they are output for display. The video coding system 100 may employ any of a variety of mechanisms to maintain the DPBs 124, 126, such as through the use of adaptive memory control commands as specified by Annex C of the H.264 specification.

During transmission over the communication channel 106, the encoded bitstream 114 may be subject to various transmission errors or other errors that may corrupt a reference picture included in the encoded bitstream 114. As one or more pictures in the encoded bitstream 114 may have been predictive encoded based on this reference picture, the corrupted reference picture prevents the decoder 120 from correctly decoding any predictive pictures based thereon. This may introduce perceptible visual artifacts in the displayed pictures. Accordingly, the encoder 112 and the decoder 120 maintain a feedback channel 128 through which the decoder 120 may notify the encoder 112 of a corrupted reference picture. In response to such indication, the encoder 112 may employ an inter-coding-based error recovery process as described more fully below. The feedback channel 128 may be incorporated as part of the communication channel 106 (e.g., as an upstream link in the communication channel 106), or may be implemented as a sideband channel utilizing a different communication pathway. Further, in some embodiments, the feedback channel 128 may be implemented as part of the feedback signaling typically utilized by a decoder to signal its parameters and capabilities to an encoder so that the encoder can configure the encoding process accordingly.

In response to detecting corruption of a reference picture, the decoder 120 signals the corrupted reference picture to the encoder 112 via the feedback channel 128, such as by including a picture count or other picture identifier associated with the corrupted reference picture. In response to this feedback, the encoder 112 determines whether there currently is a long-term reference picture in the DPB 124 that is “earlier” in the encoding order than the reference picture that was corrupted. If so, the encoder 112 reconfigures its operation so as to begin encoding at least the picture currently being processed for encoding using the identified earlier long-term reference picture from the DPB 124 in place of the reference picture that was corrupted. As the DPB 126 is synchronized to the DPB 124, the decoder 120 has access to a copy of this earlier reference picture, and therefore can use this copy of the earlier reference picture to decode the one or more pictures encoded by the encoder 112 using the earlier reference picture in response to the corrupted reference picture. Moreover, the encoder 112 signals the reference picture as a non-reference picture, thereby changing its status in the DPBs 124, 126. Because this process involves the swapping of one reference picture for another, a switch to an intra-coding-based error recovery can be avoided, and thus a significant increase in the bitrate of the encoded bitstream 114 to enact the error recovery may be avoided.

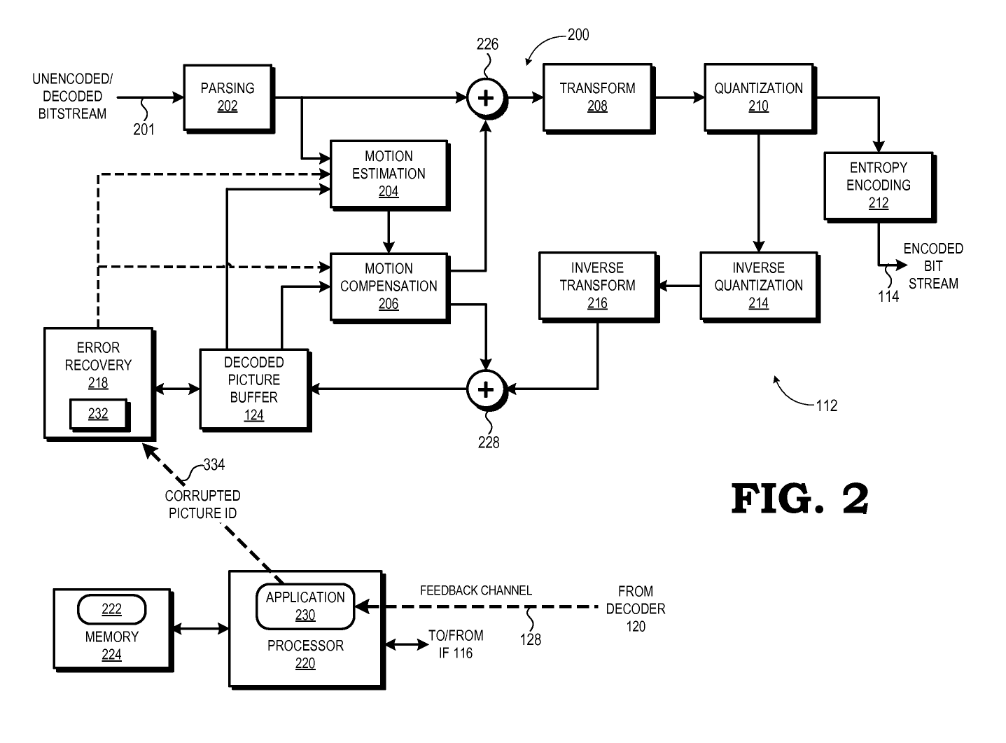

FIG. 2 illustrates an example implementation of the encoder 112 of the source device 102 in accordance with some embodiments of the present disclosure. As shown, the encoder 112 includes an encoding pathway 200 for encoding an unencoded or decoded bitstream 201 from the multimedia content source 108 so as to output the encoded bitstream 114. The encoding pathway 200 includes a parsing module 202, a motion estimation module 204, a motion compensation module 206, a transform module 208, a quantization module 210, an entropy encoding module 212, an inverse quantization module 214, an inverse transform module 216, an error recovery module 218, and the encoder-side DPB 124. The modules 202, 204, 206, 208, 210, 212, 214, 216, and 218 may be implemented as hardcoded logic or a programmable logic device, such as in an application specific integrated circuit (ASIC) or an field-programmable gate array (FPGA), as one or more processors 220 executing one or more sets of executable instructions (e.g., software 222) stored in a memory 224 or other non-transitory computer readable storage medium, or a combination thereof. As but one example, those modules providing low latency or high-throughput operations, such as modules 202-216, may be implemented in an ASIC or programmable logic device, whereas the error recovery module 218 may be implemented by the processor 220 executing software 222.

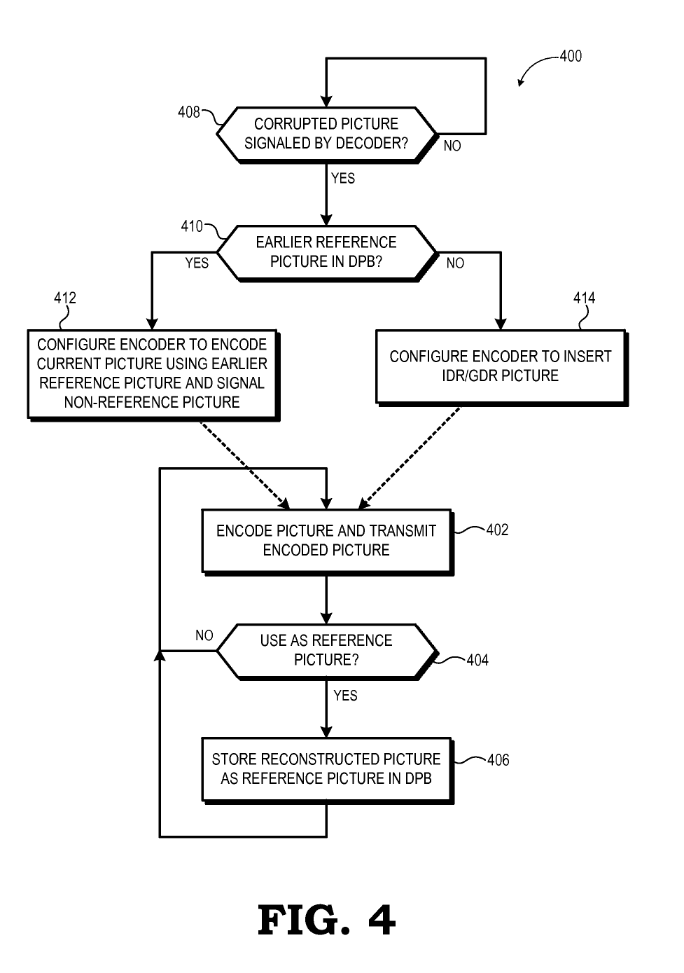

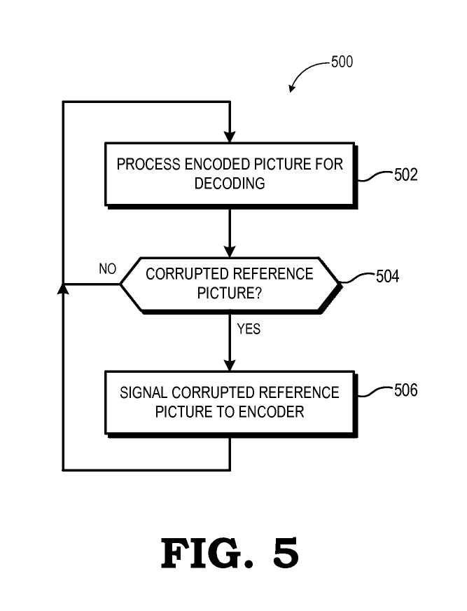

As the encoding operations of the modules 202-216 are well known to those skilled in the art, it is unnecessary to provide a detailed description of each module. In general, the parsing module 202 operates to parse the input bitstream 201 into a series of macroblocks, coding tree units (CTUs), or the like (referred to herein collectively as “pixel blocks”). For each pixel block of a picture to be predictively encoded, the motion estimation module 204 searches the reference pictures in the DPB 124 for the most-similar pixel block and generates a motion vector representing the difference in location, or “motion”, of the pixel block and the most-similar block. The motion compensation module 206 generates a predicted pixel block using the motion vector generated by the motion estimation module 204 or using intra-coding. The output of the motion compensation module 206 is combined with the parsing module 202 via the combiner 226 to generate the “residue” representing the differences between the predicted pixel blocks and the original pixel blocks. The transform module 208 applies a discrete cosine transform (DCT) or other transform to the output of the combiner 226. The transformed output of the transform module 208 is then quantized by the quantization module 210, and the result is then encoded using the entropy encoding module 212 to generate the encoded bitstream 114. Further, the encoder 112 operates to model the operation of the decoder 120, and thus decoding process is emulated at the encoder 112 via the inverse quantization module 214, the inverse transform module 216, a combiner 228, and the motion compensation module 206 to reconstruct a decoded representation of the encoded picture being transmitted in accordance with the parameters or other configuration of the decoder 120. The resulting decoded picture then may be stored in the DPB 124 as either a reference picture or as a non-reference picture. The operation of the error recovery module 218 is described below with reference to FIGS. 4 and 5.

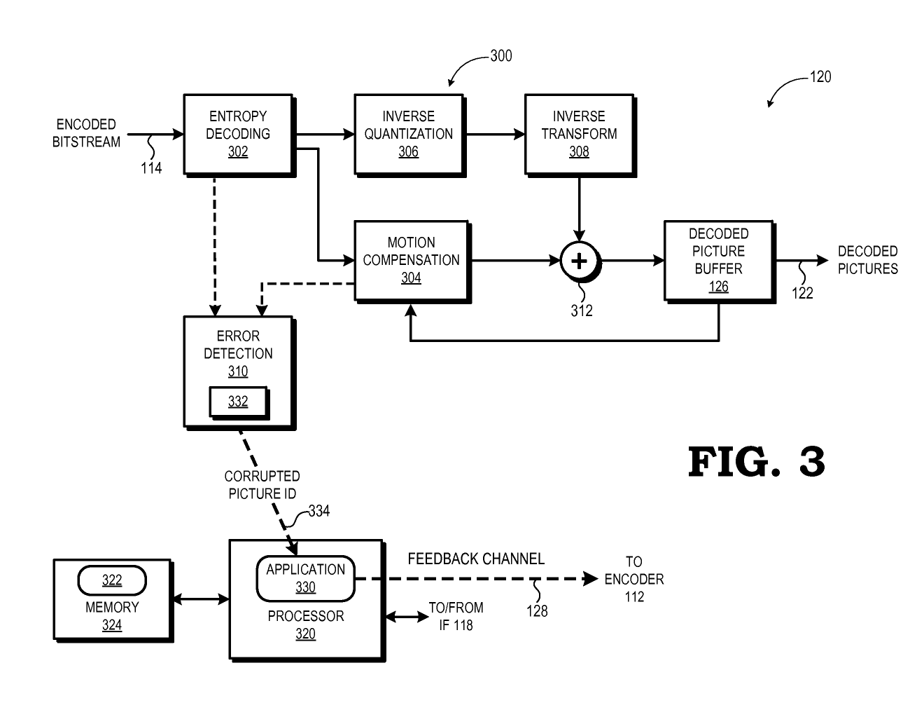

FIG. 3 illustrates an example implementation of the decoder 120 of the destination device 104 in accordance with some embodiments of the present disclosure. As shown, the decoder 120 includes a decoding pathway 300 for decoding the encoded bitstream 114 received from the source device 102 so as to generate the decoded bitstream 122 for output to the display 110. This decoding pathway 300 includes an entropy decoding module 302, a motion compensation module 304, an inverse quantization module 306, an inverse transform module 308, an error detection module 310, and the decoder-side DPB 126. As with the modules of the encoder 112, the modules 302, 304, 306, 308, and 310 may be implemented as hardcoded logic or programmable logic device, as one or more processors 320 executing one or more sets of executable instructions (e.g., software 322) stored in a memory 324 or other non-transitory computer readable storage medium, or a combination thereof.

As the decoding operations of the modules 302-308 are well known to those skilled in the art, it is unnecessary to provide a detailed description of each module. In general, the entropy decoding module 302 operates to decode the encoded bitstream 114 into its constituent elements, including intra-coded pixel block information, motion vector information, and residue information. The residues are inverse quantized by the inverse quantization module 306 and the inverse transform module 308 applies an inverse DCT (IDCT) or other inverse transform to the output of the inverse quantization module 306. For inter-coded blocks, the motion compensation module 304 utilizes the motion vector and reference picture information to generate the predicted pixel block from the reference pictures stored in the DPB 126. For intra-coded blocks, the predicted pixel block is generated from the current picture by utilizing the intra coding mode. A combiner 312 combines the output of the inverse transform module 308 and the motion compensation module 304 to generate the sequence of decoded pictures represented by the decoded bitstream 122. Some or all of the decoded pictures may be stored in the DPB 126, as either or both of reference pictures or pictures for display. The operations of the error detection module 310 are described below with reference to FIGS. 4 and 5.

The H.264 and H.265 specifications provide for a classification of pictures stored in reference buffers, such as the DPBs 124 and 126, as well as for the use of command signaling to facilitate the synchronization of reference pictures stored at the encoder and the decoder. Generally, a decoder or reconstructed picture may be marked as: “unused for reference”—signaling that the reconstructed picture is not to be used as a reference picture; “display only”—signaling that the reconstructed picture is to be stored temporarily until the picture is displayed (often not used on the encoder-side reference buffer); “short-term reference picture”; or “long-term reference picture.” As consistent with the H.264/H.265 specifications, the DPBs 124, 126 each may maintain a short-term reference picture sliding window buffer to store up to X most-recent short-term reference pictures (X representing the number of entries in the sliding window buffer) and to maintain storage for one or more long-term reference pictures. By default, a picture to be stored as a reference picture in either of the DPB 124 or the DPB 126 is marked as a short-term reference picture and added to this sliding window buffer, which may cause the automatic removal of the oldest short-term reference picture in the sliding window buffer if it is already full. In contrast, a reference picture selected for storage as long-term reference picture is maintained in the corresponding DPB until it is explicitly removed or replaced.

The DPB 126 of the decoder 120 may be similarly configured as the DPB 124 so as to have a sliding window buffer for short-term reference pictures as well as having storage for one or more long-term reference pictures. Typically, the encoder 112 inserts control signaling into the encoded bitstream 114 so as to signal to the decoder 120 which encoded pictures in the encoded bitstream 114 are long-term reference pictures to be maintained in the DPB 126, as well as to signal which long-term reference pictures have been evicted from the DPB 124 at the encoder 112, which in turn triggers the decoder 120 to evict the corresponding copy from its DPB 126. As such, this control signaling may be used to synchronize the DPBs 124, 126 so that they each maintain the same long-term reference pictures.

FIGS. 4 and 5 illustrate example methods of operation of the encoder 112 of FIGS. 1 and 2 and the decoder 120 of FIGS. 1 and 3 in accordance with at least one embodiment of the present disclosure. In particular, FIG. 4 depicts the encoding and error-recovery process implemented by the encoder 112 with reference to the example configuration of FIG. 2, and FIG. 5 depicts the corresponding decoding and error-detection process implemented by the decoder 120 with reference to the example configuration of FIG. 3.

The example encoding method 400 of FIG. 4 (employed by the encoder 112) initiates at block 402 with the access of an unencoded or decoded picture at the encoder 112. The encoder 112 encodes this picture to generate an encoded picture and inserts the encoded picture into the encoded bitstream 114 for transmission to the destination device 104. As explained above, this encoding process can include the inter-coding of the picture whereby the picture is encoded based on its similarities and differences with one or more reference pictures stored in the encoder-side DPB 124. As also explained above, the encoding process further can include reconstructing the picture from the encoded picture so as to model the operation of the decoder 120.

At block 404, the encoder 112 determines whether to use the reconstructed picture as a reference picture. This decision may be based on, for example, the position of the picture within a group of pictures (GOP), based on a capability of the multimedia application, the capability of the encoder 112, an evaluation of the content of the picture or the motion between the picture and a preceding or following picture, and the like. For example, in an IPBBPBB encoding sequence, the multimedia application can pass down encoding parameters to configure the encoder 112 to avoid use of an encoded B picture as a reference picture. The multimedia application could also force the current encoded picture to be utilized as a long-term reference picture. In the event that the reconstructed picture is not selected as a reference picture, no further action is taken with regard to the picture. However, if the reconstructed picture is selected for use as a reference picture, at block 406 the reconstructed picture is stored in the DPB 124 as a reference picture. In the event that the reconstructed picture is selected as a short-term reference picture, the reconstructed picture is stored in the sliding window buffer of short-term reference pictures, as described above, and is assigned an identifier (ID) based on its entry in the sliding window buffer. Otherwise, if the reconstructed picture is selected as a long-term reference picture, the reconstructed picture is assigned a long-term reference ID and stored in the DPB 124. The process of blocks 402-406 then repeats for the next picture in the decoding sequence of the encoded bitstream 114.

Concurrent with the picture encoding process of blocks 402-406, the error recovery module 218 monitors, at block 408, for signaling from the decoder 120 in the feedback channel 128 that indicates that the decoder 120 has detected a corrupted reference picture in the encoded bitstream 114 as received by the destination device 104. As shown in FIGS. 2 and 3, the feedback channel 128 may be implemented as an application-level channel (in terms of the Open Systems Interconnection (OSI) model) that is maintained between a source-side application 230 (FIG. 2) and a destination-side application 330 (FIG. 3), with the source-side application 230 executed by the processor 220 in support of the generation of the encoded bitstream 114 and the streaming of the encoded bitstream 114 to the destination device 104 and the destination-side application 330 executed by the processor 320 in support of the decoding of the encoded bitstream 114 and the display of the resulting decoded bitstream 122. When the error detection module 310 of the decoder 120 detects a corrupted reference picture, the error detection module 310 signals this event to the error recovery module 218 via the applications 230, 330 and the feedback channel 128.

In response to receiving signaling indicating a corrupted reference picture, at block 410 the error recovery module 218 determines whether the encoder-side DPB 124 currently contains a suitable long-term reference picture that is earlier in encoding order than the picture that has been corrupted. The respective timing of reference pictures in the DPB 124 compared to the corrupted picture may be assessed in a variety of ways. To illustrate, in one embodiment, the error recovery module 218 maintains, or has access to, a free-running counter 232 (FIG. 2) that is incremented with each encoded picture inserted into the encoded bitstream 114. When a reconstructed picture is selected for storage as a reference picture in the DPB 124, the error recovery module 218 may append or otherwise associate the current count value of the counter 232 with the reference picture as it is stored in the DPB 124. As such, each reference picture stored in the DPB 124 is effectively assigned an ID or timestamp that represents its position in the encoding order. The error detection module 310 at the decoder 120 likewise maintains a free running counter 332 that is incremented with each picture processed by the decoder 120, and thus the error detection module 310 may include assign the current count value of the counter 332 to each picture as it is processed. Thus, when the error detection module 310 detects a corrupted picture, the error detection module 310 may include the assigned count value for the corrupted picture as a corrupted picture ID 334 in the signaling provided via the feedback channel 128 to indicate the corrupted picture. The error recovery module 218 then may access the DPB 124 to determine whether any suitable reference pictures (e.g., long-term reference pictures) stored therein have a picture ID that is lower (i.e., “earlier” in this implementation) than the picture ID 334 of the corrupted reference picture. In other embodiments, relative position in the encoding order may be indicated by position within a queue or other buffer within the DPB 124, and thus an earlier long-term reference picture may be identified based on its position within this queue or buffer relative to the reference picture identified as corrupted.

As described above, the DPBs 124, 126 may separate reference pictures into short-term reference pictures and long-term reference pictures, and it may be only the long-term reference pictures which are reliably synchronized between the encoder-side DPB 124 and the decoder-side DPB 126 and therefore suitable candidates for selection as a replacement reference picture for the corrupted reference picture. To illustrate, the DPB 126 may have a smaller sliding window buffer for short-term reference pictures than the DPB 124, and thus the DPB 124 may have some short-term reference pictures that are not currently in the DPB 126. Accordingly, in at least some embodiments, the error recovery module 218 limits its selection of an earlier reference picture to only one of the long-term reference pictures stored in the DPB 124. That is, the error recovery module 218 omits short-term reference pictures of the DPB 124 from the selection process in order to identify the available reference frame used for error recovery in a timely manner.

In the event that the DPB 124 has a suitable earlier reference picture, at block 412 the error recovery module 218 selects the most recent earlier long-term reference picture (in the event that there are multiple qualified long-term reference pictures that are earlier than the corrupted reference picture) and then configures the encoder 120 to utilize the selected earlier long-term reference picture in place of the reference picture that has been corrupted or otherwise been subjected to a transmission error on the decoder side. For the picture being encoded by the current iteration of the process of block 402, this can include, for example, restarting the encoding of the picture using the earlier long-term reference picture in place of the corrupted reference picture, or by switching reference pictures at the current point in the encoding process, with the understanding that the portion of the picture encoded using the corrupted reference picture may not be accurately decoded by the decoder 120. Switching the earlier reference picture for the corrupted reference picture may be implemented in any of a variety of ways. For example, the corrupted reference picture may be signaled as non-reference picture from the DPBs 124, 126 via control signaling from the encoder 112, with the expectation that the encoding process will then default to using the selected earlier long-term reference picture for inter-coding of pictures as it is most spatially similar to the reference picture that was corrupted.

Returning again to block 410, in the event that the error recovery module 218 determines that the DPB 124 does not have a suitable earlier reference picture stored therein, at block 414 the error recovery module 218 configures the encoder 112 to recover from the corrupted reference picture either through insertion of either an IDR picture or a GDR picture (or intra-refresh) using any of a variety of IDR or GDR processes known in the art.

As illustrated by the error recovery process of blocks 408-414, the encoder 112 may utilize a suitable earlier reference picture, when available, in place of a corrupted reference picture to continue predictive encoding of pictures within a GOP without resorting to intra-coding, and thus may recover from the corrupted picture with relatively minimal increase in bitrate necessary to affect the error recovery. In the event that a suitable earlier reference picture is not available for substitution, then the encoder 112 may implement a conventional intra-coding-based error recovery process, albeit with the increased bit rate typically incurred by such processes.

FIG. 5 illustrates an example method 500 for decoding an encoded bitstream and detecting corrupted reference pictures contained therein in accordance with at least one embodiment of the present disclosure. The method 500 initiates at block 502, wherein the decoder 120 accesses the next encoded picture for decoding from the received encoded bitstream 114 and initiates decoding of the encoded picture. Prior to, during, or after the decoding process, at block 504 the error detection module 310 evaluates whether the picture is a reference picture, and if so, whether the data representing the reference picture was corrupted due to a transmission error, such as through detection of errors in the bitstream at the picture level, the slice level, the MB level, and the like. If so, at block 506 the error detection module 310 signals the corrupted status of the reference picture to the error recovery module 218 of the encoder 112 via the feedback channel 128. As noted above, the error detection module 310 may maintain the free running counter 332 to number pictures as they are received, and the error detection module 310 may include the current count of the counter 332 as the corrupted picture ID 334 so as to identify which reference picture was corrupted during the transmission process. The process of blocks 502-506 then may repeat for the next encoded picture accessed from the encoded bitstream 114.

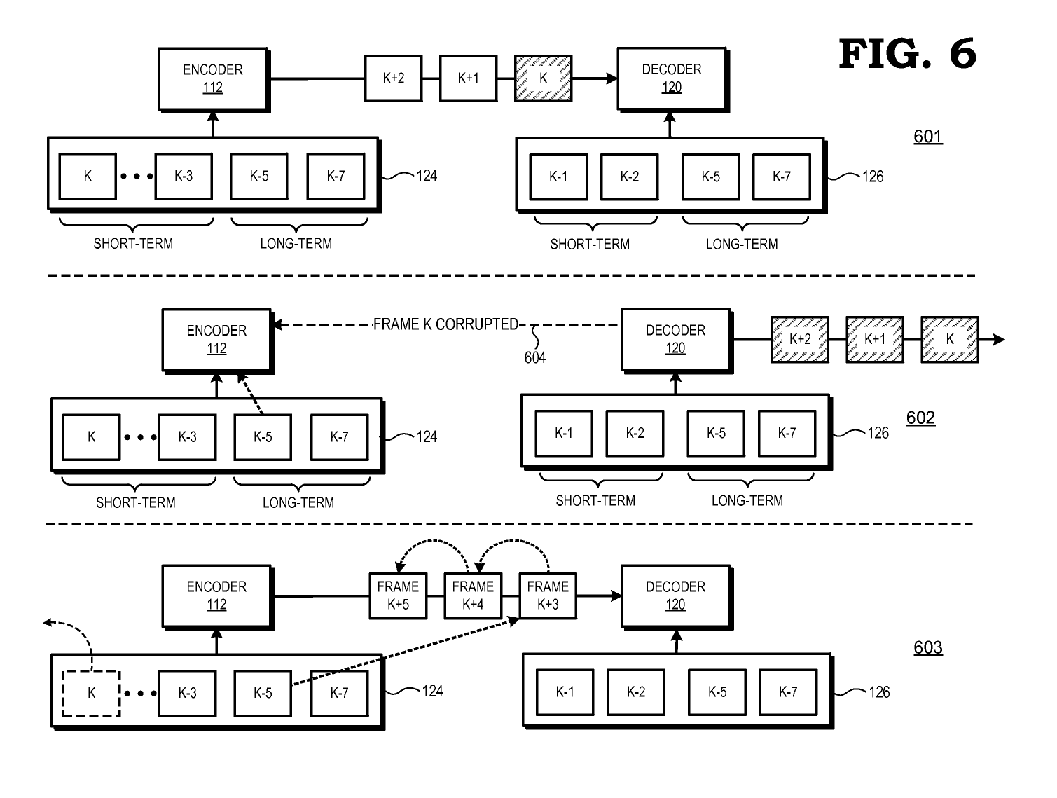

FIG. 6 illustrates an example scenario in which the inter-coding-based error recovery is implemented to recover from corrupted reference picture in accordance with at least one embodiment. The top panel 601 of FIG. 6 illustrates an initial state of the video coding system 100 in which the encoder 112 has inserted encoded pictures K, K+1, and K+2 into the encoded bitstream 114 for transmission to the decoder 120. In this example, picture K is a reference picture, and as depicted by the shading in FIG. 6, has been corrupted during the transmission process.

As depicted in the middle panel 602, the decoder 120 detects the corrupted status of the reference picture K, and thus provides a signal 604 to the encoder 112 via the feedback channel 128, where the signal 604 includes a picture ID associated with picture K. In response, the encoder 112 searches the DPB 124 and identifies picture K-5 as being a long-term reference picture that is earlier in the decoding order than picture K. In the meantime, the decoder 120 has decoded pictures K, K+1, and K+2 on the basis of the corrupted picture K, and thus the decoded versions of pictures K, K+1, and K+2 may have perceptible visual aberrations when displayed.

As depicted by the bottom panel 603, in response to identifying picture K-5 as a long-term reference picture suitable for replacing the corrupted reference picture, the encoder 112 is reconfigured to use picture K-5 as a reference picture in place of picture K, and picture K is signaled as non-reference picture from the DPB 124 and the DPB 126. In the illustrated example, this results in pictures K+3 being inter-coded using picture K-5 as a reference picture. Picture K+4 then may be encoded using K+3 as a reference picture, and picture K+5 can be encoded using picture K+4 as a reference picture. Thus, as shown in FIG. 6, a transmission error that impacted the reference picture K is contained so as to impact only a limited number of decoded pictures (pictures K, K+1, and K+2) and is recovered from without requiring the bitrate-intensive insertion of an IDR picture or a GDR picture or other intra-coding process.

In some embodiments, the apparatus and techniques described above are implemented in a system comprising one or more integrated circuit (IC) devices (also referred to as integrated circuit packages or microchips), such as the encoder 112 or the decoder 120 described above with reference to FIGS. 1-6. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory tangible storage medium, or combination of non-transitory tangible storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. In a video coding system, a method comprising:
transmitting a first encoded picture from an encoder for reception by a decoder as part of an encoded bitstream, the first encoded picture being a first reference picture for one or more subsequent pictures in the encoded bitstream;
receiving, at the encoder, an indication from the decoder that there was an error in receiving the first encoded picture;
selecting a second reference picture from a first buffer of reference pictures at the encoder, the second reference picture being earlier than the first reference picture in an encoding order of the encoded bitstream; and
configuring the encoder to encode a current picture for the encoded bitstream using the second reference picture and to signal the first reference picture as non-reference picture in the first buffer of reference pictures.

2. The method of claim 1, wherein:
selecting the second reference picture and configuring the encoder comprise selecting the second reference picture and configuring the encoder in response to the first buffer having a reference picture earlier than the first reference picture in the encoding order.

3. The method of claim 2, further comprising:
in response to the first buffer not having a reference picture earlier than the first reference picture in the encoding order, configuring the encoder to encode at least one of an instantaneous decoder refresh (IDR) picture or a graduated decoder refresh (GDR) picture for insertion into the encoded bitstream.

4. The method of claim 1, wherein:
selecting the second reference picture comprises limiting selection of the second reference picture to one of a set of one or more long-term reference pictures in the first buffer of reference pictures.

5. The method of claim 1, further comprising:
receiving the indication from the decoder at the encoder via a feedback channel between the decoder and the encoder in response to detecting the error in receiving the first encoded picture at the decoder.

6. The method of claim 1, further comprising:
transmitting the encoded bitstream from the encoder to the decoder via a communication channel comprising at least one network.

7. A device comprising:
an interface to a communication channel; and
an encoder coupled to the interface, the encoder comprising:
a first buffer to store one or more reference pictures;
an encoding pathway coupled to the first buffer, the encoding pathway to generate a first encoded picture for an encoded bitstream, wherein the first encoded picture is used as a first reference picture for one or more subsequent pictures; and
an error recovery module coupled to the first buffer and to the encoding pathway, the error recovery module to configure the encoder to encode a set of one or more pictures using a second reference picture and signal the first reference picture as non-reference picture in the first buffer in response to receiving an indication from a decoder that there was an error in receiving the first encoded picture, the second reference picture selected from the first buffer as being earlier than the first reference picture in an encoding order.

8. The device of claim 7, wherein:
the error recovery module is to select the second reference picture and configure the encoder in response to the first buffer having a reference picture earlier than the first reference picture in the encoding order.

9. The device of claim 8, wherein:
in response to the first buffer not having a reference picture earlier than the first reference picture in the encoding order, the error recovery module is to configure the encoder to encode at least one of an instantaneous decoder refresh (IDR) picture or a graduated decoder refresh (GDR) picture for insertion into the encoded bitstream.

10. The device of claim 7, wherein:
the first buffer is to store a set of one or more short-term reference pictures and a set of one or more long-term reference pictures; and
wherein the error recovery module is to limit selection of the second reference picture to one of the set of one or more long-term reference pictures in the first buffer.

11. A device comprising:
a decoder coupleable to an encoder via a feedback channel, wherein the decoder comprises:
an input to receive an encoded bitstream having a first encoded picture, wherein the first encoded picture is used as a first reference picture for one or more subsequent pictures;
a buffer to buffer reference pictures from the encoded bit stream; and
an error detection module to:
send to the encoder via a feedback channel an indication that there was an error in receiving the first encoded picture in response to detecting the error in receiving the first encoded picture at the decoder; and
to identify the first reference picture as a non-reference picture in the buffer in response to a signal from the encoder indicating the first reference picture is to no longer be used as a reference picture; and
a decoding pathway to decode one or more subsequent pictures of the encoded bitstream using a second reference picture from the buffer in place of the first reference picture.

12. The device of claim 11, wherein:
the buffer maintains copies of a set of long-term reference pictures stored in a corresponding buffer of the encoder.

13. The device of claim 11, wherein:
the decoder further comprises a counter incremented for each picture processed from the encoded bitstream; and
the error recovery module further is to include in the indication a count value of the counter that is associated with the first reference picture.

14. In a video coding system, a method comprising:
receiving, at a decoder, an encoded bitstream having a first encoded picture, wherein the first encoded picture is used as a first reference picture for one or more subsequent pictures;
buffering reference pictures from the encoded bit stream in a buffer of the decoder;
sending to the encoder via a feedback channel an indication that there was an error in receiving the first encoded picture in response to detecting the error in receiving the first encoded picture at the decoder;
identifying the first reference picture as a non-reference picture in the buffer in response to a signal from the encoder indicating the first reference picture is to no longer be used as a reference picture; and
decoding, at the decoder, one or more subsequent pictures of the encoded bitstream using a second reference picture from the buffer in place of the first reference picture.

15. The method of claim 14, further comprising:
maintaining in the buffer copies of a set of long-term reference pictures stored in a corresponding buffer of the encoder.

16. The method of claim 14, further comprising:
incrementing a counter of the decoder for each picture processed from the encoded bitstream; and
including in the indication a count value of the counter that is associated with the first reference picture.

17. A non-transitory computer readable storage medium embodying a set of executable instructions to manipulate at least one processor to
provide a first encoded picture for transmission to a decoder as part of an encoded bitstream, the first encoded picture presenting a first reference picture for one or more subsequent pictures in the encoded bitstream;
receive an indication from the decoder that there was an error in receiving the first encoded picture;
select a second reference picture from a buffer of reference pictures of an encoder, the second reference picture being earlier than the first reference picture in an encoding order of the encoded bitstream; and
configure the encoder to encode a set of one or more pictures for the encoded bitstream using the second reference picture and signal the first reference picture as a non-reference picture.

18. The non-transitory computer readable storage medium of claim 17, wherein:
the executable instructions to manipulate the processor to select the second reference picture and configure the encoder comprise executable instructions to manipulate the processor to select the second reference picture and configure the encoder in response to the buffer having a reference picture earlier than the first reference picture in the encoding order.

19. The non-transitory computer readable storage medium of claim 18, wherein the set of executable instruction further are to manipulate the processor to:
in response to the buffer not having a reference picture earlier than the first reference picture in the encoding order, configure the encoder to encode at least one of an instantaneous decoder refresh (IDR) picture or a graduated decoder refresh (GDR) picture for the encoded bitstream.

20. The non-transitory computer readable storage medium of claim 17, wherein:
the executable instructions to manipulate the processor to select the second reference picture comprise executable instructions to manipulate the processor to limit selection of the second reference picture to one of a set of one or more long-term reference pictures in the first buffer of reference pictures.
